(19) United States
(12) Patent Application Publication
(10) Pub. No.: US 2002/0010641 A1
(43) Pub. Date: Jan. 24, 2002

(54) Low cost system method apparatus and way of doing business for the conveyance and electronic labeling and transference of secure multimedia and data products

(76) Inventors: Jessica L. Stevens, San Mateo (CA); Bonnie A. Crystal, San Mateo, CA (US); Steven C. Weiss, San Jose, CA (US)

Correspondence Address: TELISAR CORPORATION, 1840 GATEWAY DRIVE, SUITE 200, SAN MATEO, CA, 94404, US

(21) Appl. No.: 09/835,020

(22) Filed: Apr. 13, 2001

Related U.S. Application Data
(60) Provisional application No. 60/201,159, filed on May 2, 2000.
(60) Provisional application No. 60/207,095, filed on May 25, 2000.
(60) Provisional application No. 60/259,993, filed on Jan. 4, 2001.
(60) Provisional application No. 60/259,994, filed on Jan. 4, 2001.

(51) Int. Cl. G06F 17/60

(52) U.S. Cl. 705/26

(57) ABSTRACT

A portable receiving system for receiving data products and data product information. The system includes a portable data unit and a subscriber interface unit. The portable data unit includes a broadcast signal receiver for receiving at least one of a data product or data product information modulated with a broadcast signal, a processor for separating the at least one data product or data product information from the broadcast signal by demodulating the broadcast signal, memory for storing the separated at least one data product or data product information, a presentation device for presenting the separated at least one data product or data product information, and a user interface for allowing selection of a data product associated with the presented data product or data product information. The subscriber interface unit includes a network interface for connecting the subscriber interface unit to a data product center over a communications network, and an interface for connecting to the portable data unit.

### FIELD OF THE INVENTION

This invention relates to delivery and reception of data products.

### BACKGROUND OF THE INVENTION

Consumer purchase of data products, such as software that take some form of video games, computer programs, music, videos, preformatted databases, or other temper preformatted digital data, is performed within a few limited environments. The consumer can go to a computer data products store, such as a software reseller, and purchase computer programs stored on various types of digital media, such as compact discs, or floppy discs. Since the advent of the Internet, consumers no longer need to go to a dedicated store for the purchase of a data product, they can now access a website and download the desired data product from the website. This ability to retrieve data products without leaving one's home has provided a significant advantage over the store purchase of data products. Despite the significant advantages over previous methods of purchasing data products this method of downloading at a personal computer coupled to the Internet still has some significant limitations. The delivery of data products must occur over a connection to the Internet. If a user hears a song from a radio broadcast or sees a software product on a television broadcast that they wish to own or sample, they must remember the song or product then access a personal computer and connect to the Internet. Then, the user must find a website that provides for the downloading of the remembered song or software product. If the user hears the song or sees the software product at a location remote from their or any other personal computer, they may forget what they heard or saw before they can access the computer.

Therefore, there exists a need for allowing consumers to retrieve data products at anytime without the requirement of having to use a computer for accessing a vendor over the Internet.

### SUMMARY OF THE INVENTION

The present invention comprises a system and methods for distributing data products to end-users by embedding the data within a broadcast radio or television signal, or over a similar channel within a cable television system. The system includes a portable data unit and a subscriber interface unit. The portable data unit includes a broadcast signal receiver for receiving at least one of a data product or data product information modulated with a broadcast signal, a processor for separating the at least one data product or data product information from the broadcast signal by demodulating the broadcast signal, memory for storing the separated at least one data product or data product information, a presentation device for presenting the separated at least one data product or data product information, and a user interface for allowing selection of a data product associated with the presented data product or data product information. The subscriber interface unit includes a network interface for connecting the subscriber interface unit to a data product center over a communications network, and an interface for connecting to the portable data unit.

In accordance with further aspects of the invention, the subscriber interface unit further includes a processor, memory, a user interface and a display device. The subscriber interface unit also includes a broadcast signal receiver.

In accordance with other aspects of the invention, the network interface is a personal computer interface.

In accordance with still further aspects of the invention, the portable data unit is shaped similar to an audio cassette and the subscriber interface unit is shaped to receive the portable data unit. A portion of the memory is removable from the portable data unit.

In accordance with yet other aspects of the invention, the portable data unit includes an output component for generating a signal for reception by at least one of an analog or digital cassette recorder.

In accordance with still other aspects of the invention, the data product is combined into an existing broadcast transmission in a manner so as not to unacceptably interfere with the quality of the carrier transmission.

In accordance with still yet other aspects of the invention, the data product is secured through encryption, broadcast to a plurality of end-users, who purchase keys to unlock the data product.

Through the use of the system and methods of the present invention, data products may securely be purchased by end users or received by users if the product is intended to be freely distributed. These and further embodiments are taught below.

### BRIEF DESCRIPTION OF THE DRAWINGS

The preferred embodiment of the present invention is described in detail below with reference to the following drawings:

FIG. 1 is a system diagram;

FIGS. 2 and 3 are block diagrams of components of the system of FIG. 1;

FIGS. 4A and B are flow diagrams illustrating a method performed by the present invention;

FIGS. 5A-D are bit stream diagrams;

FIGS. 6-11 are perspective diagrams of various embodiments of components of the present invention;

FIG. 12 is a diagram of a radio wave;

FIGS. 13 and 14 are block diagrams illustrating visually the method described in FIGS. 4A and B;

FIGS. 15-18 and 21 are block circuit diagrams;

FIGS. 19 and 20 are diagrams illustrating places to modulate data into a video signal;

FIG. 22 is a block diagram of an embodiment of the present invention providing streaming data from N sources; and

FIGS. 23A-B are block diagrams of the transmitter and receiver, respectively, of an embodiment of the present invention providing N channels of digital audio embedded within a broadcast signal.

### DETAILED DESCRIPTION OF THE PREFERRED EMBODIMENT

The present invention provides an improved system and method for the ordering, storing, encrypting, broadcasting, receiving, decrypting, porting and using data products. The data products are preferably software application programs, music files, such as MP-3 files, video files, such as MPEG or Quicktime files, database files or portions or samples of any of the above. Hence, the term “data product” as used herein encompasses any of the wide variety of forms of data that are presently sold in shrink-wrap form or as a commodity. While the discussion will be directed primarily to such data products, the present invention may provide such transference not only of such data products but also of any other data that a user may need to receive from the supplier.

The system of the present invention broadcasts the data product to the user over traditional television, radio or other frequencies, or over cable television on an existing channel. If the data is to be sent securely to the user, it will be broadcast in an encrypted format and the user may purchase or otherwise obtain an appropriate data key to decrypt the transmission.

An Illustrative Data Delivery System

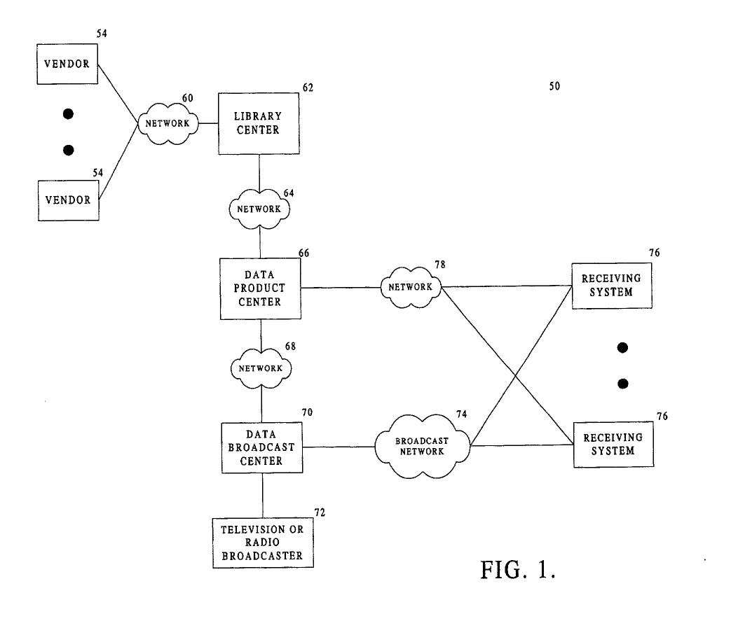

An example system 50 formed in accordance with the present invention is illustrated in FIG. 1. The system 50 includes a plurality of vendors 54 in data communication with a Library Center 62 across a network 60. The Library Center 62 is in communication with a Data Products Center 66 across a network 64. The Data Products Center 66 is in communication with a Data Broadcast Center 70 across a network 68 and a plurality of receiving systems 76 across a network 78. The networks 60, 64, 68 and 78 are one of a landline or wireless, public or private data network, such as the Internet, a satellite network or any type of private network. The Data Broadcast Center 70 is also in communication with a television or radio broadcaster 72. The Data Broadcast Center 70 is in broadcast communication with the receiving systems 76 across a broadcast network 74. In another embodiment, the network 74 is a cable modem or Digital Subscriber Line (DSL) that remains continuously active or active for extended periods of time. The Data Products Center 66 or Data Broadcast Center 70 are in communication with the Subscriber Interface Unit 92 through this always on network connection.

The vendors 54 are producers or repackagers of data products, such as software, music or video producers or retailers. The vendors 54 generate data products, such as software application programs, music, video, or some other form of data, and transmit the generated data products to the Library Center 62 across the network 60.

In an alternate embodiment, the vendors 54 send a storage device, such as a compact disk, that includes the data products to the Library Center 62. The Library Center 62 processes incoming data products as necessary. For example, if a data product is received on a compact disk, it is reformatted and digitally stored as required by the system 50. The Library Center 62 stores the data products received from the vendors 54 in lossless form as master copies.

Also, the Library Center 62 stores highly compressed and lossy forms of the same data products depending upon the type of data product. For example, music and video data products are stored in lossy form, however, software application programs are stored in lossless form.

Other factors affect how data products are stored within the Library Center 62. For example, different levels of compression resolution may exist for a single data product depending upon the types of selections that are made available for purchase or sampling by users or subscribers. The degree of loss acceptable is determined according to the reproduction capabilities of the receiving system 76, the cost of receiving content at specific data rates and content quality levels, the choices available to subscribers and other communication and control data.

The Library Center 62 also stores other information pertinent to the stored data products, such as decryption or encryption information, cataloging information, pricing information, data product samples, data product information, promotional material, or any other information pertinent to the data products. The Library Center 62 also includes a new releases or prereleases database for storing, newly released or prereleased data products.

The Data Products Center 66 retrieves data products, data product samples, or other stored data product-related information from the Library Center 62 according to requests from a subscriber, or stored data product or other instructions.

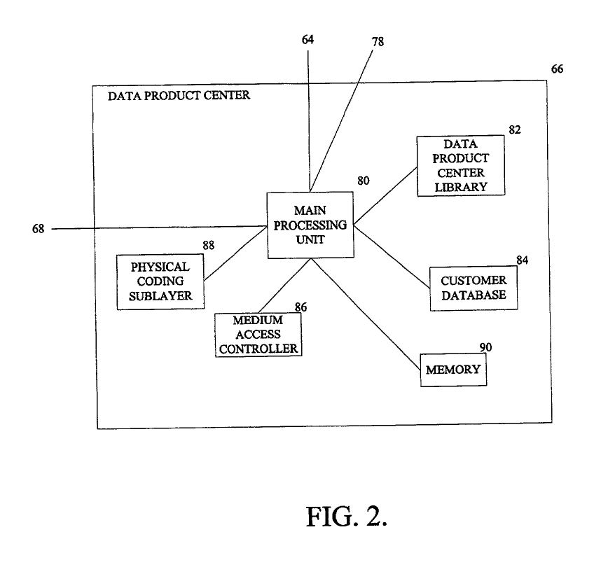

FIG. 2 illustrates components of the Data Products Center 66. The Data Products Center 66 includes a main processing unit 80 coupled to a Data Products Center library 82, a customer or subscriber database 84, a medium access controller 86, and a physical coding sublayer 88. The Data Products Center library 82 stores data products and related information available to subscribers and can store the same information stored in the Library Center 62, thereby eliminating the need for a separate library. Data products are stored in encrypted form for greater security and to reduce processing time prior to transmission or in unencrypted form for greater storage efficiency. Certain data products such as video, audio graphics may be stored in the Data Products Center library 82 under various levels of lossy compression, depending upon such factors as the data product type, cost, and frequency of subscriber requests. The customer database 84 includes customer account records, such as subscriber identification, encryption keys, credit limits, transaction history, authorizations to particular types or ratings of data products, registered equipment information, such as the type and quality of the Subscriber Interface Unit 92 and the Portable Data Unit described below, reception channels and reception performance history. The Data Products Center 66 also includes a memory 90 coupled to the main processing unit 80 that includes system operation records, such as account information, Library Center record information, encryption and decryption keys for system transmission and reception. The memory 90 also includes encryption and decryption applications. The medium access controller 86 controls communication between the Library Center 62, the Data Broadcast Center 70 and receiving systems 76 across the networks 64, 68 and 78. The physical coding sublayer 88 performs channel encoding and decoding for encoding and decoding the data product information to a bit rate for a determined channel type. The main processing unit 80 includes interfaces for providing communication across the networks 64, 68 and 78.

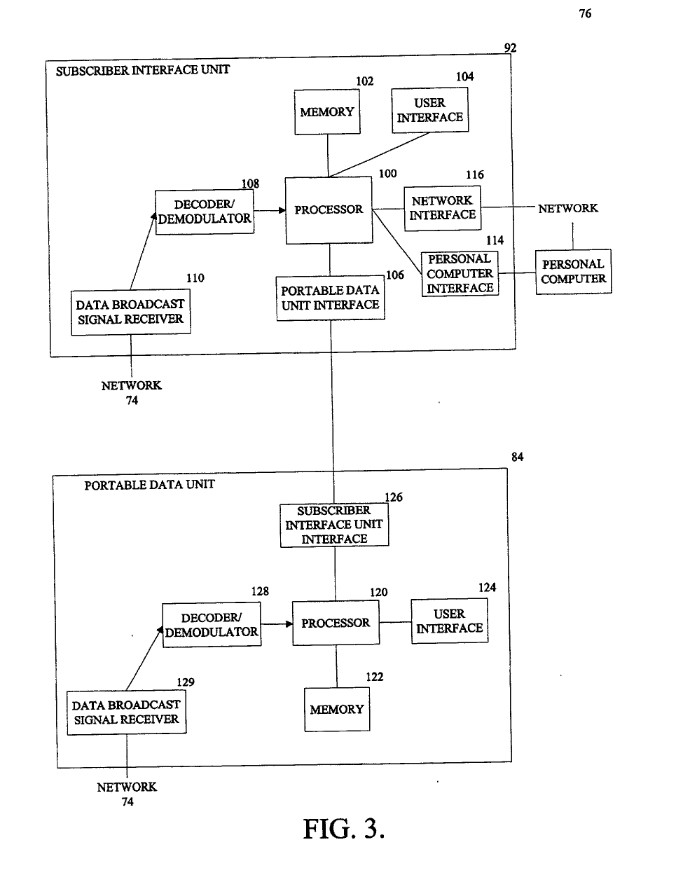

As shown in FIG. 3, an embodiment of the receiving system 76 includes a Subscriber Interface Unit 92 and a Portable Data Unit 94. The subscriber Interface Unit 92 includes a processor 100 coupled to memory 102, a user interface 104, a portable data unit interface 106, a decoder/demodulator 108, and a data broadcast signal receiver 110. Memory 102 in some embodiments will be a high capacity memory, of either fixed or removable format. For communicating with the Data Product Center 66, the Subscriber Interface Unit 92 includes a personal computer interface 112 for providing communication with a personal computer 114 or similar device that is in communication with the network 78 or a network interface 116 that directly connects the Subscriber Interface Unit 92 to the network 78.

The data broadcast signal receiver 110 receives signals from the broadcast network 74 via an antenna, a connection to a satellite signal receiver, or a cable. The data broadcast network 74 is a landline or wireless broadcast network, such as radio frequency, cable or satellite broadcast television. The data broadcast signal receiver 110 sends the received broadcast signals to the decoder/demodulator 108 for decoding/demodulating, as necessary, then to the processor 86 for preparing for presentation to the subscriber through the user interface 104, for storing of or presenting on the Portable Data Unit 94 through the portable data unit interface 106, or for storing at or presenting on a personal computer or similar device through the personal computer interface 114.

The Portable Data Unit 94 with a processor 120 coupled to memory 122, a user interface 124, and a subscriber interface unit interface 126. Memory 122 in some embodiments will be a high capacity memory, of either fixed or removable format. In some embodiments memory 122 may be capable of storing a set of encryption keys that are transportable for use in decrypting data products resident on any of a plurality of Subscriber Interface Units 92. Such keys may be of a permanent or temporary nature, as described in greater detail below. In this embodiment the data product may be kept in encrypted form and only decrypted when needed and when a Portable Data Unit 94 holding a corresponding encryption key is present. Alternatively, memory 122 will store decrypted data products.

In an alternate embodiment, the Portable Data Unit 94 includes a decoder 128 and a data broadcast signal receiver 129 that are coupled to the processor 120 for allowing the Portable Data Unit 94 to receive broadcasted signals without requiring connection to the Subscriber Interface Unit 92. In an alternate embodiment, the Portable Data Unit 94 includes a personal interface 114 for providing communication with a personal computer or similar device that is in communication with the network 78 or the network interface 116 that directly connects the Portable Data Unit 94 to the network 78.

At least one of the user interfaces 104 or 124 includes a “Buy-Me” button. When a user selects the “Buy-Me” button while data product information is being presented to a user, the corresponding processor 100 or 120 generates a download request. The download request is a request for the downloading or delivery of the data product associated with the presented data product information. For example, if a graphic emblem associated with a certain band's album appears on one of the displays of the user interfaces 104 or 124, the user can request for the songs of that band's album be scheduled for delivery. This request constitutes a purchase request, whereby the user is billed after completion of successful delivery.

Ordering and Delivery Methods

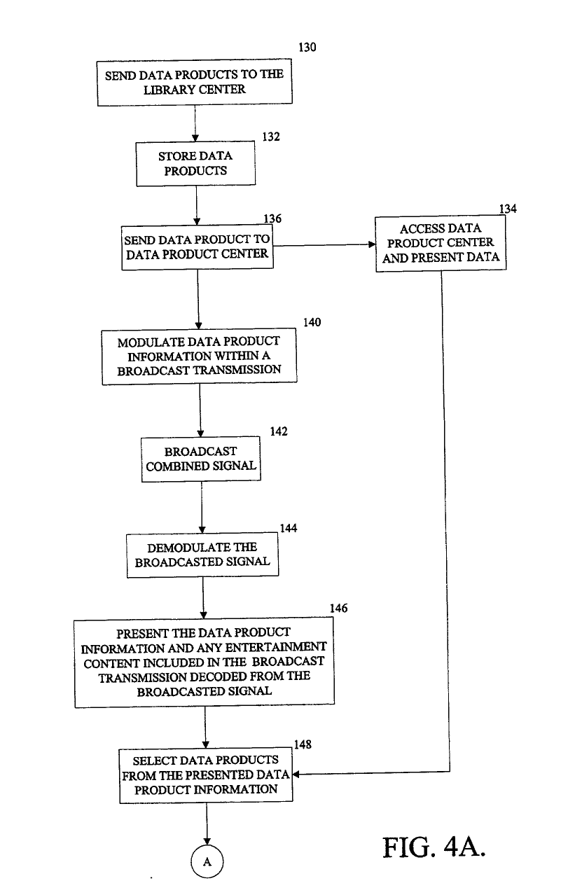

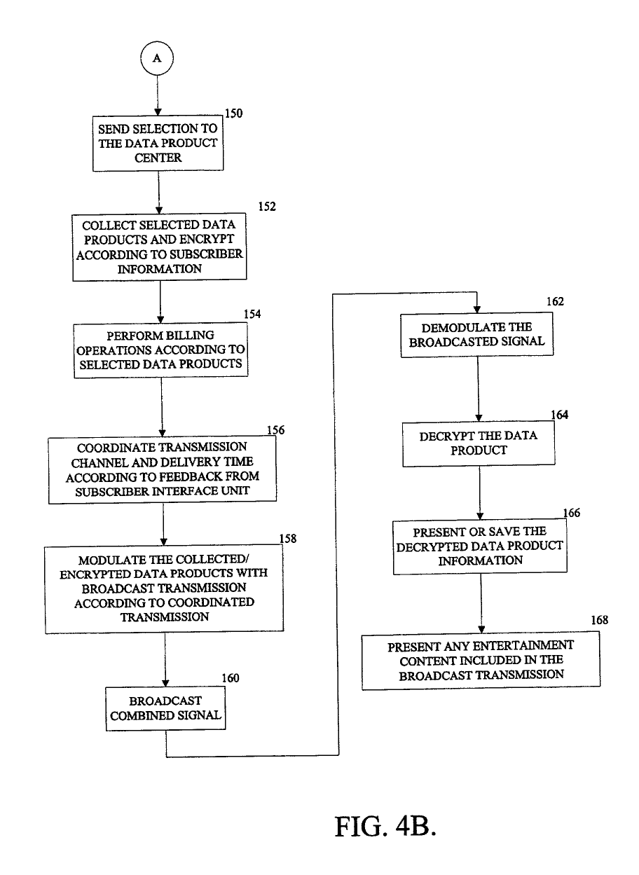

FIGS. 4A and B show an example process performed by the components illustrated in FIGS. 1-3. Before a user can interact with the system 50, the user provides registration information to the Data Product Center 66. The Data Product Center 66 stores the registration information within the customer database 84 for data product transaction processing. Also, the user is given access to a receiving system 76, a Portable Data Unit 94 alone or in combination with a Subscriber Interface Unit 92 or a system that can perform the features provided by units 92 and 94. The system 50 also prepares for transactions by having the vendors 54 send data products and related information to the Library Center 62 across the network 60, see block 130.

Then, at block 132, the received data products and related information are stored according to numerous factors, such as the data product type (e.g. audio or software applications) and quality (e.g. image or audio quality), the method and quality of delivery (e.g. exclusive data broadcast, combined broadcast, channel quality), or other factor relating to the sale, sampling, or delivery of a data product or related information.

After block 132, the user views what data products are available for sale or sampling by accessing the Data Product Center 66 over the network 78 or by receiving data product information included in a signal broadcasted by the Data Broadcast Center 70 over the broadcast network 74.

Access of the Data Product Center 66 over the network 78 may be accomplished in a variety of ways. For example, network 78 may comprise a public-switched telephone network using either landline or wireless networks. Access may be obtained by dialing a toll-free central number (800/8xx number) or a local point-of-presence (POP). A voice interface comprising menus, human operator and/or other methods known in the art could be used to allow the user to identify and order data products. In such an embodiment the Automatic Number Identification (ANI) for the originating call may be used to identify the user and to confirm the identity of the user. In addition, the Subscriber Interface Unit 92 or the Portable Data Unit 94 may generate identification signals that assist in confirming the identity of the user.

Alternatively, network 78 may comprise an internet-connection or other computer-to-computer communication system, such as directly dialing into a local point-of-presence (POP). Ordering of data products could be facilitated by use of text menus and/or other methods known in the art. In such an embodiment the I.P. address of the computer or other identification signal (including passwords) may be used to verify the identity of the user.

If the user accesses the Data Products Center 66 to make a data product selection, the process continues to block 134, where the receiving system 76 presents available data products to the user from information received over the network 78 from the Data Products Center 66.

However, if the user makes a selection from data product information broadcasted by the Data Broadcast Center 70, the process continues to block 136. At block 136, data product information is sent from the Library Center 62 to the Data Products Center 66, if not already stored at the Data Products Center 66. At block 140, the Data Broadcast Center 70 receives from the Data Products Center 66 the data product information and modulates the data product information in a new broadcast transmission or in a broadcast transmission received from the television or radio broadcaster 72 to produce a combined broadcast signal. Transmission coding and modulation techniques are described in more detail below. The combined broadcast signal is then broadcast, at block 142, over the broadcast network 74. Next, at block 144, the decoder/demodulator 108 or 128 decode/demodulate and separate the broadcasted signal into its precombined components. At block 146, the data product information is presented to the user over the user interface 104, 124 of the Subscriber Interface Unit 92 or the Portable Data Unit 94. Next and continuing from block 134, at block 148, the user selects one or more data products from the presented data product information.

As shown in FIG. 4B, at block 150, the Data Products Center 66 receives the data product selection(s) from the receiving system 76 across the network 78. At block 152, the Data Product Center 66 collects the selected data product(s) from either the Data Product Center library 82 or from the Library Center 62. The selected data product is then encrypted as necessary. At block 154, the Data Product Center 66 performs billing operations for the selected data product.

Then, at block 156, either the Data Product Center 66 and/or the Data Broadcast Center 70 determines and coordinates transmission characteristics for transmission of the collected data products. The transmission characteristics include various transmission information necessary to generate a modulated broadcast signal with the collected data product modulated therein to provide for acceptable reception of the data product within acceptable degradation levels of the carrier signal. The various transmission information includes, for example, channel, station, network, and system identification, receiving system control data, bit stream format information, and other control information some of which is attained by communication, such as handshaking, between the Data Products Center 66, the Data Broadcast Center 70 and the receiving system 76 (the Subscriber Interface Unit 92 or the Portable Data Unit 94). Other actions, or functions related to those occurring in block 152-156, that the Data Products Center 66 or Data Broadcast Center 70 performs upon reception of a data product request include performing suitable or optimum channel determination for transmission of the requested data product, quoting a price, determining delivery time of the data product, soliciting and confirming payments for the data product, scheduling transmission of the data product, if not already scheduled, and sending the proper digital key information.

Then, at block 158, the Data Broadcast Center 70 encodes and modulates the collected data products in an unused broadcast signal or within a broadcast signal received from the television or radio broadcaster 72 according to the coordinated transmission characteristics to create an analog baseband signal containing modulated data. Various known forms of modulation can be used. The combined broadcast signal is then broadcast by the Data Product Center 70, see block 160. The combined broadcast signal is compatible with existing commercial standard television broadcast systems and any governmental regulations, such as NTSC, SECAM or PAL.

The receiving system 76, specifically the Subscriber Interface Units 92 or the Portable Data Unit 94, decodes and demodulates the broadcast signal in order to extract the data product, see block 162. Next, at block 164, in accordance with a preselected encryption method, the Subscriber Interface Unit 92 or the Portable Data Unit 94 decrypts the data product demodulated from the broadcast signal. At block 166, the decrypted data product is presented on the user interface of the Subscriber Interface Unit 92 or the Portable Data Unit 94 or saved within the Portable Data or Subscriber Interface Units' memory 123, 102, removable storage or within systems with similar characteristics. Finally, at block 168, any entertainment content included in the broadcast transmission is presented.

Digitized Video Data Products

This embodiment may be best understood in light of an example application, e.g., digitized video. Such digitized video may be broadcast on a predetermined schedule (pay-per-view), requested by the individual user (video on demand), or provided continuously on a subscription-basis (premium broadcast service). Alternatively, the video (or other data product) may be preordered and transferred when the product becomes available. The digitized video would be stored at the Library Center 62 and then forwarded to the Data Product Center 66, see block 136.

In the case of pay-per-view video, the video product would be embedded in an encrypted format into a broadband transmission at block 140 and then the combined signal would be broadcast at block 142. Those with the Subscriber Interface Unit 92 according to the present invention would be able to demodulate the combined signal at block 144 to retrieve the embedded video signal (block 146). The user would have to order a key in order to decrypt the video signal and view the video transmission. Hence, only those paying for the broadcast could view the video program.

In the case of video-on-demand, the user would receive a selection menu of available products and would order a desired product at block 134, at which time the financial transaction would be completed and the keys to the data exchanged. Transmission of the signal would then be scheduled and the user informed of the time of transmission. Transmission would be accomplished using the techniques described elsewhere herein.

Streaming Audio and Video Data Products

In several embodiments of the present invention, no security of the data is desired and hence no need for keys. One example would be a multiplexed signal comprising a plurality of streaming digitized audio and/or video signals. Such streaming digitized signals may comprise live broadcasts of data or transmission of prerecorded audio, video or other data products that are to be distributed without encryption. Examples of some products that may be distributed in this manner are samples, material that is useless without another application that is previously purchased by the user, content paid by advertising revenue, material provided as a public service or other products distributed without charge. In addition, upgrades to the system software may be accomplished using such unencrypted transmission.

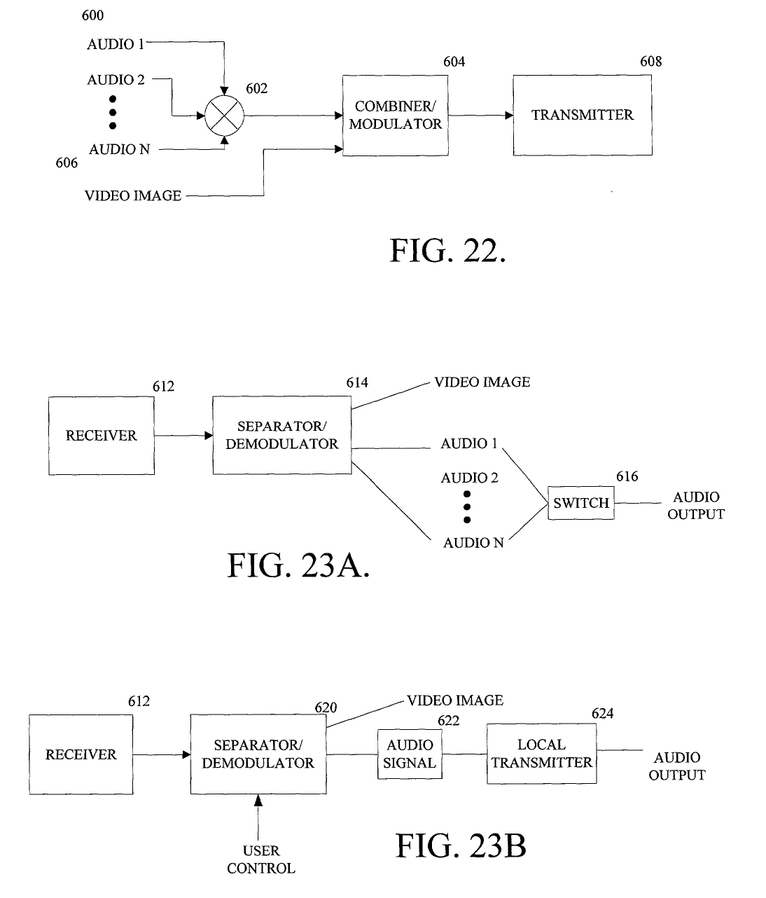

Such an embodiment for a plurality of N audio channels is illustrated in FIG. 22 (similar embodiment incorporating one or more video channels is also in accordance with the present invention). Audio inputs 600 are multiplexed by a multiplexer 602. The multiplexed signal is then combined by a combiner/multiplexer 604 with a video signal 606 to be broadcast.

The combined signal is then broadcast by a transmitter 608 and received by a receiver 612 of FIG. 23A or 23B, the receiver 612 is located within the Subscriber Interface Unit 92 or Portable Data Unit 94. In the embodiment shown in FIG. 23A, a separator/demodulator 614 separates the received signal into the original video signal 606 and N audio output channels. A switch 616 is used to determine which audio output channel is used. In the embodiment of FIG. 23B, a separator/demodulator 620 separates the received signal into the original video signal 606 and a user-selected audio output signal 622 selected by user control. The audio output signal 622 can then be transmitted by a local transmitter 624 to an audio output on a radio frequency unused in the locality of the user.

In this way a simulated radio signal may be produced local to Subscriber Interface Unit 92 or Portable Data Unit 94 that can be received on ordinary radio stations. Such a signal would comprise a sub-micro broadcast signal, preferably of a power output below that requiring government licensure.

Burst Mode Transmission

Prerecorded audio and video data products may be transmitted through “burst mode.” “Burst Mode” is a mode of transmission that takes advantage of the network's ability to time compress data products prior to transmission. In an embodiment of the invention, an audio program, for example an hour of a radio station's broadcast, is significantly time compressed. The audio program could be prerecorded and compressed, or a buffer may be used that is significantly longer than the time needed for transmission.

In either case, such a compressed program could then be transmitted in far less time than it would take to transmit the program live, such transmission occurring as a “burst” of data. Subscriber Interface Unit 92 or Portable Data Unit 94 of the user may then receive the data product and play it in real-time after receipt. In such cases the user may even be unaware that the program is thus compressed and previously transmitted.

The remaining time available from the broadcast station may be used to transmit other data product. In one embodiment of the present invention, multiple radio stations (“virtual stations”) might use the same broadcast frequency and broadcast in different time slots within the time unit, with the user being able to select which virtual station to listen to at any given moment. This would allow multiple stations to share the same broadcast frequency, and would allow the user to access many more radio stations.

Alternatively, a single station may use its facilities to broadcast other types of data products in addition to its regular programming. If, for example, an existing radio station were to use such transmission in lieu of present real-time broadcasting, those users with Subscriber Interface Units 92 or Portable Data Units 94 would be able to listen to the station as if it were live, and the station would have significant transmission bandwidth available to broadcast other data product content.

Such data product multiplexing need not use long time slots (such as an hour). The time slots could be shorter, and longer programs may be divided into smaller bursts, as long as the system and Subscriber Interface Unit 92 or Portable Data Unit 94 are configured to allow such multiplexed signals and each burst contains any identifier information needed to reconstruct the complete program.

These multiplexed bursts may also utilize error-correction approaches, from as simple as redundant broadcast of packets (broadcasting the same packet several times) to advanced Forward-Error Correction (FEC) coding. Such approaches would help ensure that momentary fading of signal does not result in substantial loss of program content. The use of more packets with shorter duration also helps to ensure that less content is lost from missing packets. However, there is always an overhead associated with packetizing data, and there will be a tradeoff between packet overhead loss and risk of content loss in determining the optimal length of burst signals.

Transmission of Data Products Prior to Purchase

In another embodiment, a Subscriber Interface Unit 92 with a large amount of storage space downloads data products (popular or otherwise) or categories of data products previously selected by the subscribers. Each Subscriber Interface Unit 92 maintains and updates and internal catalog of encrypted data products in its memory 102. These catalogs contain electronic labels of text and graphics, audio or video information that was downloaded with corresponding data products. The electronic labels describe the corresponding data products listed in the catalogs and are presented as the subscriber searches through the catalog or some portion thereof. A data product is decrypted when the subscriber requests purchase or rent of limited or unlimited licensing of the data product, after the Subscriber Interface Unit 92 receives an electronic key(s) from the Data Product Center 66 or the Data Broadcast Center 70.

In an alternate embodiment the Subscriber Interface Unit 92 continuously scans transmitting Data Broadcast Centers 70 for new or updated data products, or related information and automatically downloads it.

Each Subscriber Interface Unit 92 discards oldest, least-played or least-used data products when new memory space is required in order to make room for newly requested data products. The selection method for material to be discarded may either be predetermine for the system or selectable by the user, depending upon the specific implementation of the present invention.

Encryption keys may enable unlimited use by a subscriber or set subscribers with Subscriber Interface Units. Alternatively, keys that enable limited use would expire after a certain period of time. A metering component is coupled to the use of a such keys, wherein usage of a data product or set of data products is metered to determine number of uses, length of time of usage, quantity of data used, required, sent or processed or other metric of usage or consumption. The metering component is preferably a software component that allows usage of data products as long as allowed by the agreement for their usage. Such agreements allow usage on a prepaid basis, on a post-paid basis, according to stored subscription information, or on a sample basis.

Buy-Me Button

The “Buy Me” button is an optional feature of Portable Data Unit 94 that allows product ordering with a minimal number of user actions, including in some embodiments, a single push of a button. Although the “Buy Me” button is a button labeled “Buy Me” in one embodiment, it also refers to any of a variety of labeled features that allow product selection. Hence, it may be implemented in various embodiments as a button, switch, key, soft-key, selectable (clickable) user interface feature, graphic or icon on a screen, voice command, audio tone, or another other action, which when taken, corresponds to a menu selection indicated by visual, audio or tactile means. Such labeling may include the words “Buy Me” or any of a variety of messages in a variety of languages, including pictographic representations.

The “Buy Me” button, when active, operates to instruct Portable Data Unit 94 or Subscriber Interface Unit 92 to send signals, using the variety of transmission modes available to Portable Data Unit 94 or Subscriber Interface Unit 92, to a vendor network to initiate or otherwise conduct transactions related to ordering of products.

The “Buy Me” button would be active when Portable Data Unit 94 is synchronized with a data channel, and in an embodiment of the invention, an advertising channel (advertising channel here meaning a transmission channel that is either dedicated to advertisements or that is carrying an advertisement at the time of usage). For example, the advertising channel may be an electronic label on Portable Data Unit 94, or may be an infomercial on television, or an advertisement on radio.

In one embodiment of the invention, transactions may be completed with a single push of the “Buy Me” button. In this embodiment, when Portable Data Unit 94 is synchronized with the advertising channel, depressing the “Buy Me” button will automatically conduct the transaction for the advertised product without the usual authorization steps that require locating the product in a catalog, verifying that the product is the desired product, etc. When the “Buy Me” button is used, the transaction is completed without further input required of the user.

Because the “Buy Me” button provides the possibility of accidentally ordering undesired products, in some embodiments of the present invention the user may deactivate the button. In one such embodiment, activation of the “Buy Me” button could require entry of a password, to allow the user to restrict access to such purchases. This could function as a parental control over a child's ability to order product.

In alternative embodiments of the invention, the “Buy Me” button may be used as part of a two-step ordering process. In one such embodiment, operation is as described above for a one-step order, but an additional verification step would be added. The ordered product could be displayed on the electronic label or other display, and either a second confirmation press could be entered, an order-cancellation operation initiated, or the user could select a different product.

For example, a user might depress the “Buy Me” button after observing a selection on the electronic label, hearing a broadcast advertisement or watching an infomercial. The selected product would be displayed, and the user might cancel the order with a push of a button, confirm with a second push of the “Buy Me” button, or scroll through previous or subsequent selections using selection buttons.

In another alternate embodiment of the invention, the “Buy Me” button is used in conjunction with an auction for any product, either a data product or other product. A description, images, etc. related to the auction item may be broadcast as described above in accordance with the invention, embedded within a broadcast signal. The “Buy Me” button may be used either to bid in a standard increment, or to confirm a bid determined either by a user-selected increment or a user-selected maximum bid price.

Error Correction

Different types of data products, or agreements tolerate varying bit error rates, from zero for executable software code or some documents to some tolerable higher levels for audio, video or similar content. In an embodiment of the present invention the modulation format or data transmission rate may be modified for different data types to ensure reception of data within the acceptable error tolerance range.

One method of performing error correction of the data modulated into an analog broadcast signal is any one of a number of Forward Error Correction (FEC) techniques. However, non-correctable errors, erasure or non-detectable errors may still occur thereby requiring alternative methods for fixing or eliminating these problems. One method of performing this is to perform repetition of the broadcast of the data product to allow the receiving system 76 to download another version of the data product and replace any incorrect or missing data elements from the previously downloaded data products. Subsequent downloads are also used to compare to prior downloads to check for and correct undetected errors.

In another alternate correction method the receiving system 76 requests, over the network 78, that only the incorrect or missing data elements be transmitted. Such transmission is accomplished over the same or other broadcast channel and data rate. Retransmission of only the incorrect or missing data elements increases the available bandwidth for other data broadcasts.

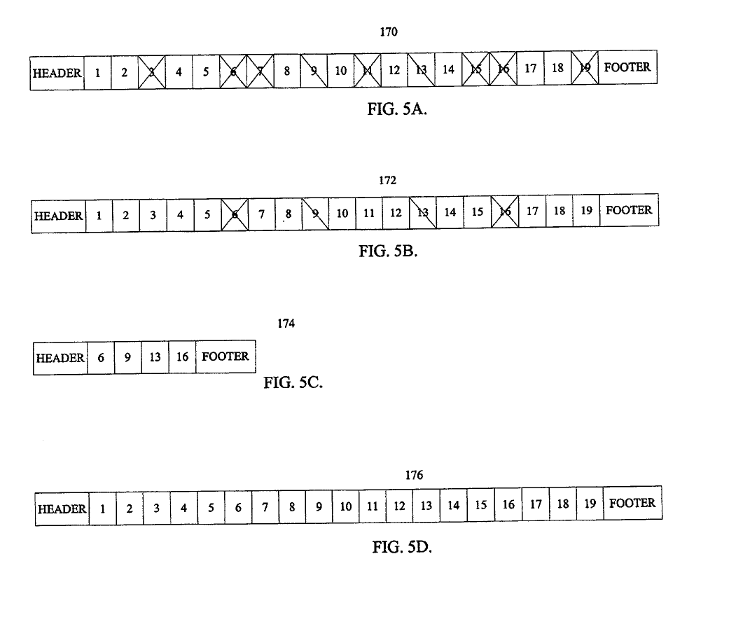

In the following example, a Subscriber Interface Unit 92 downloads a data product from a television broadcast and is able to correct most but not all of the errors. FIG. 5A illustrates a data stream 170 of uniquely numbered data elements. Elements 3, 6, 7, 11, 15, 16, and 19 are determined to include errors and elements 9 and 13 have missing components. In FIGURE SB, the Subscriber Interface Unit 92 has completed all error correction using FEC code included within the broadcast transmission to produce an almost fully error-free data stream 172. The Subscriber Interface Unit 92 was unable to correct elements 6 and 16 and 9 and 13 because they were missing. If the subscriber selects the data product associated with the partially corrected data stream 172, the Subscriber Interface Unit 92 establishes a communication link with the Data Product Center 66 across the network 78 to begin the purchasing process. The subscriber enters payment information as requested by the Data Product Center 66, then the Data Product Center 66 sends any decryption keys and the uncorrected data elements 174 (6, 9 13, and 16) to the Subscriber Interface Unit 92, see FIG. 5C. The Subscriber Interface Unit 92 inserts the data elements into the partially corrected data stream 172 replacing the incorrect and missing elements thereby generating a flawless data stream 176, see FIG. 5D.

In another embodiment, if the subscriber requests a data product from a Subscriber Interface Unit 92 that has not yet received the requested data product, the Subscriber Interface Unit 92 downloads the data product. If FEC is able to correct most but not all of the errors, the Subscriber Interface Unit 92 establishes a communication link with the Data Product Center 66 across the network 78 and requests any missing or incorrect data elements.

In any of the above error-correction systems, alternative embodiments may modify data transmissions when a large number of errors are noted. For example, if the Data Product Center 66 receives a large number of requests for corrected data, the data rate or even modulation format may be modified to improve data reception.

Example Subscriber Unit Interfaces and Portable Data Units

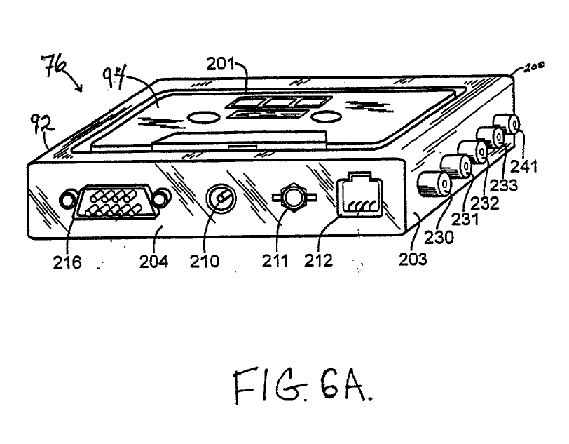

FIGS. 6A and B illustrate perspective views of an example Portable Data Unit 94 coupled to an example Subscriber Interface Unit 92. The Subscriber Interface Unit 92 is constructed with a housing 200 having a front side 202, a back side 204, and a left and right sides 203 and 205. The housing 200 forms a well 201 for receiving the Personal Data Unit 94 at a top side of the housing 200. The back side 204 includes a power connection port 210, an optical connection port 211, a telephone line connection port 212, and a data input/output (I/O) connection port 216. Other types of I/O or interface devices may be used. The left side 203 includes audio output connections 230 and 231, audio input connection ports 232 and 233, an audio speaker-microphone connection port (not shown), and a radio frequency coaxial or fiber optical connection port 241. Referring to FIG. 6B, the front side 202 of the housing 200 includes interface keys 250, a display 260, an optical transceiver sensor/emitter 240 and an infrared signal receiver/emitter 244. The interface keys 250 include alphanumeric keys 251, function keys 252, and display interface keys 253. The display 260 presents various text and graphics display information included within the received data product information. For example, the display information includes menu information 261 for presenting a data product list. A cursor 262 is displayed in proximity to the presented data product list for allowing a user to identify and select items in the data product list. The display information also presents graphical information 263, such as electronic labels, associated with the received data product information. The display information further presents function list information 264 for displaying a function list in proximity to the display interface keys 253. Activation of a display interface key activates the function of the corresponding display function list item. In an alternate embodiment the display 260 is a touchscreen display for allowing a subscriber to directly select items in the data product list or the function list 264.

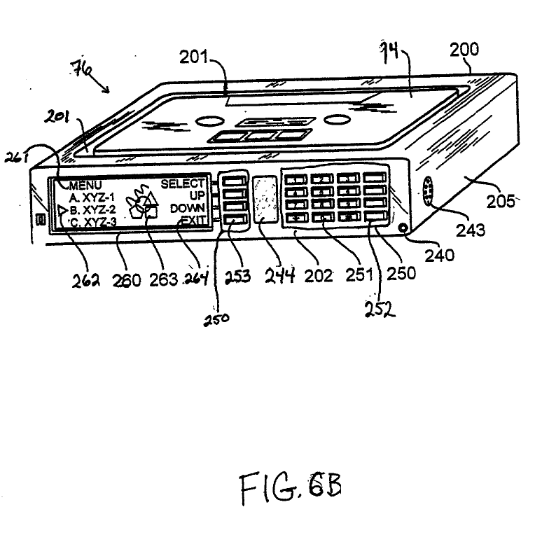

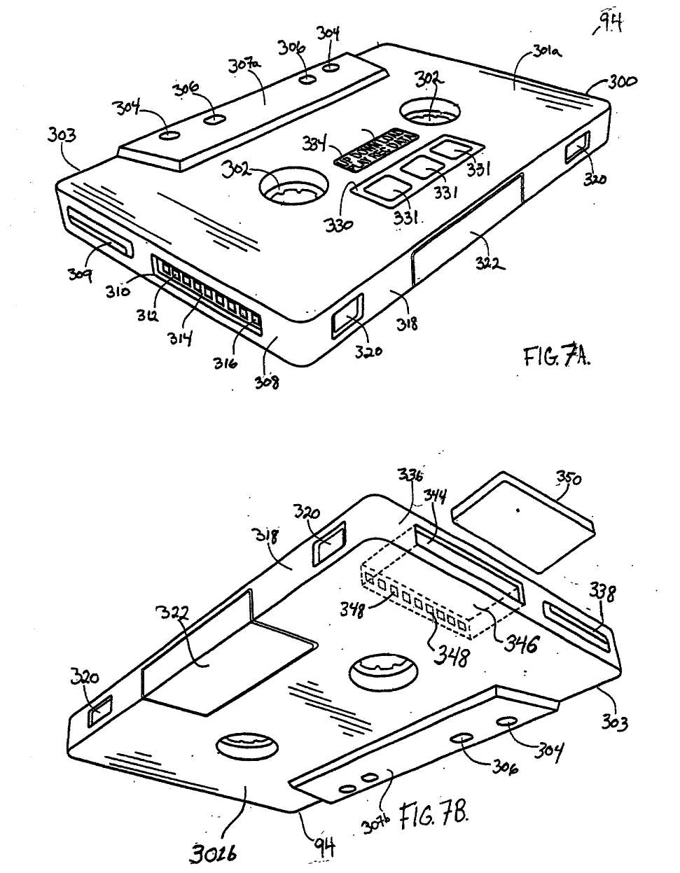

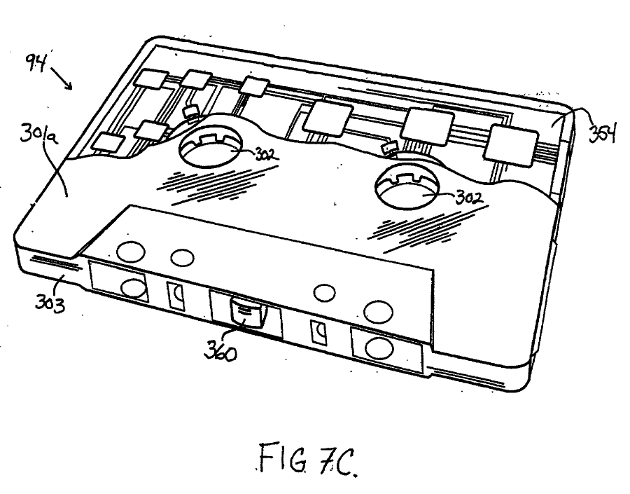

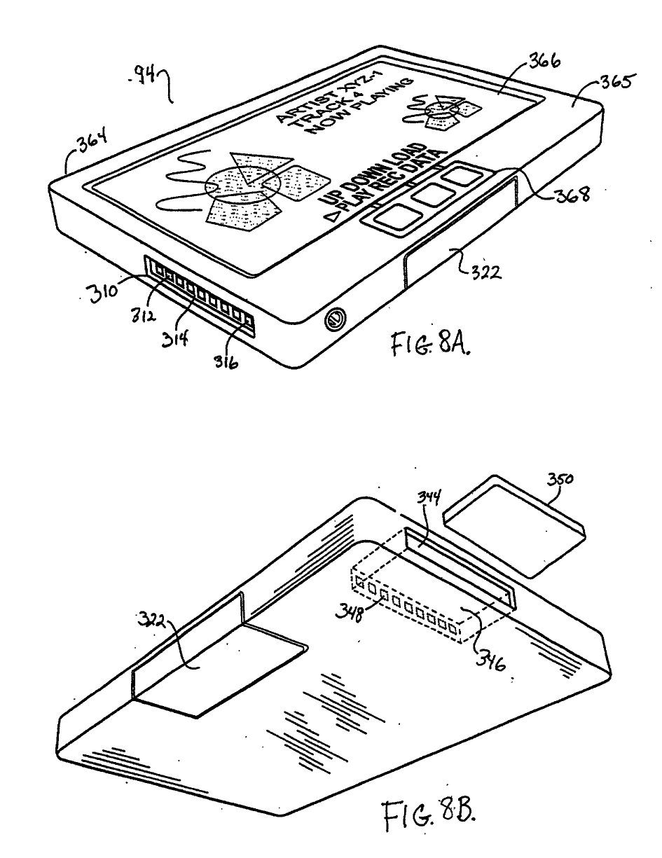

The right side 205 includes a user interface (UI) port 243 for connecting UI devices, such as a keyboard or a mouse. The housing 200 also includes other UI or I/O ports as necessary, such as a USB port. An antenna (not shown) is included as part of the housing 200 for receiving radio, television, bluetooth, or other type of wireless signals. The Portable Data Unit 94 that is received within the well 201 is shaped like an audio cassette tape and is described in more detail below in FIGS. 7A and B and in an alternate embodiment in FIGS. 8-12.

FIGS. 7A and B are perspective views of an example of the Portable Data Unit 94 with a housing 300 that is shaped liked an audio cassette tape. As shown in FIG. 7A, the housing 300 includes various components for interfacing with the subscriber, the Subscriber Interface Unit 92, and other devices. The housing 300 includes spindle holes 302 that create openings from a first side to a second side 301a, b. The spindle holes 302 are positioned for receiving the spindles of a conventional cassette deck. The housing 300 also includes forward and reverse spindle holes 304 and cassette module guide holes 306 that also create openings from the first side to the second side 301a, b near a base edge 303. The first and the second sides 301a, b include a raised edge surface 307a, b for mechanical alignment of the housing 300 and for including the holes 304 and 306. A first edge 308 of the housing 300 includes a mechanical alignment bumper 309 and a set of recessed connectors 310 that include electronic signal connectors 312, electrical power connectors 314, and module connectors 316. A top edge 318 of the housing 300 includes cassette recorder enabling tabs 320 and a housing battery door 322 that covers a battery compartment. The first side 301a includes a user interface keypad 330 with multiple user interface keys 331. A user interface display 334 for displaying text and graphical images is located on the first side 301a near the user interface keypad 330. In alternate embodiment the display 334 is a touchscreen display. The user interface keys 331 allow the user to select from functions assigned to the keys or from functions displayed on the display 334. The housing 300 has a second edge 336 parallel and opposite from the first edge 308. The second edge 336 includes a mechanical alignment bumper 338 similar to the bumper 309, and an opening 344 for receiving a removable storage unit 350 into a removable storage unit cavity 346 within the housing 300. Along a side surface within the cavity 346 are electrical leads 348 for coupling internal components of the housing 300 to the removable storage unit 350. If the Portable Data Unit 94 operates as a stand-alone unit, an antenna (not shown) is included as part of the housing 300 for receiving radio, television, bluetooth, or other type of wireless signals.

FIG. 7C is a cut-away perspective view of the example Portable Data Unit 94 illustrated in FIGS. 7A and B. Within the housing 300 is a circuit board 354 that includes some or all of the components illustrated in FIG. 3. A bottom edge 303 of the housing 300 includes a signal output lead 360 that can supply a magnetic signal for use by a conventional cassette recorder.

FIGS. 8A and B are perspective views of a housing 364 that is an alternate embodiment of the Portable Data Unit 94. In this alternate embodiment, the housing 364 has a similar shape to the housing 300, however it does not include features typical of standard audio cassette tapes, such as spindle holes and raised alignment services. The housing 364 includes a top surface 365 with a set of user interface keys 368 and a display 366. The display 366 is a flat panel display, similar to those used in cellular phones or personal digital assistants (PDA), which covers approximately the entire length and approximately two-thirds the width of the housing 364. In an alternate embodiment, the display 366 is a touchscreen display. The display 366, similar to the other displays mentioned above, is capable of presenting graphical and textual images.

FIG. 9 illustrates a Subscriber Interface Unit 92 formed as an L-shaped housing 370 that is configured to interface with a Portable Data Unit shown in FIGS. 8A and B. The L-shaped housing 370 includes electrical connectors 372 along the concave edge of the housing 370 and I/O and Ul ports, as necessary, located on a front surface 374, back surface or convex surface of the housing 370.

FIG. 10 illustrates an alternate embodiment of the Subscriber Interface Unit 92 that is used with the Portable Data Unit shown in FIGS. 8A and B. In this alternate embodiment, the Subscriber Interface Unit 92 is formed as a housing 380 with a seat for receiving a compatible Portable Data Unit 94. The seat formed by housing 380 includes electrical connectors (not shown) for connecting to connectors on the Portable Data Unit 94. The housing 380 includes I/O ports and antenna as necessary. As can be readily appreciated by those of ordinary skill in display presentations, the text and graphics displayed on the Portable Data Unit can be oriented as desired.

FIGS. 11A and B illustrate another alternate embodiment for the Subscriber Interface Unit 92 and the Portable Data Unit 94. The Subscriber Interface Unit is a block-shaped housing 390 with a top surface 392 that includes I/O and UI ports, as necessary, and also includes electrical connectors 394 for connecting to connectors 396 mounted into the bottom side of the Portable Data Unit.

In a further alternate embodiment (not shown), a credit card reader is incorporated into the Subscriber Interface Unit 92 or the Portable Data Unit 94 to allow the user to purchase the data product using a credit card. Such an embodiment would be particularly useful if the Subscriber Interface Unit 92 were incorporated into a kiosk or other station for public distribution of encrypted data products, allowing transfer to the user's Portable Data Unit 94 along with purchased encryption keys.

While all of the embodiments described herein anticipate a separate Subscriber Interface Unit 92 and/or Portable Data Unit 94, it is to be understood that either or both components may be integrated into other consumer products. For example, these may be incorporated into television receivers, stereo receivers, videocassette recorders (VCRs), cable converter boxes or other audio-visual components. These components may also be configured as cards incorporated into personal computers. In some cases such incorporation may be advantageous to allow shared usage of resources or to provide access to additional storage or communications hardware.

Data Transmission and Reception Techniques

The Data Broadcast Center 70 sequences, processes and encodes/modulates data products, related data product information and other system data into a bitstream for direct modulation of an RF signal, for replacement of the original content of an analog video signal, or for combination with an analog broadcast signal, preferably a signal generated by the television or radio broadcaster 72, and for transmission over a selected delivery channel.

FIG. 12 illustrates a radio broadcast signal 400 that is used to carry bitstream information. A radio broadcaster generates a radio signal 400 and sends it to the Data Broadcast Center 70. The Data Broadcast Center 70 processes and encodes/modulates a bitstream of data products, data product information or any other system or control data into the essentially unused sideband frequency ranges 402 of the radio signal 400. When the receiving system 76, either the Subscriber Interface Unit 92 or the Portable Data Unit 94, receives the radio signal 400 with a bitstream modulated into the sideband frequency ranges 402, the respective decoder 108 or 128 decodes/demodulates the modulated bitstream and decrypts the decoded/demodulated bit stream according to any included encrypted information. The type of modulation and encoding performed by the Data Broadcast Center 70 depends upon a number of factors, such as transmission quality, receiving system capabilities, and other system information.

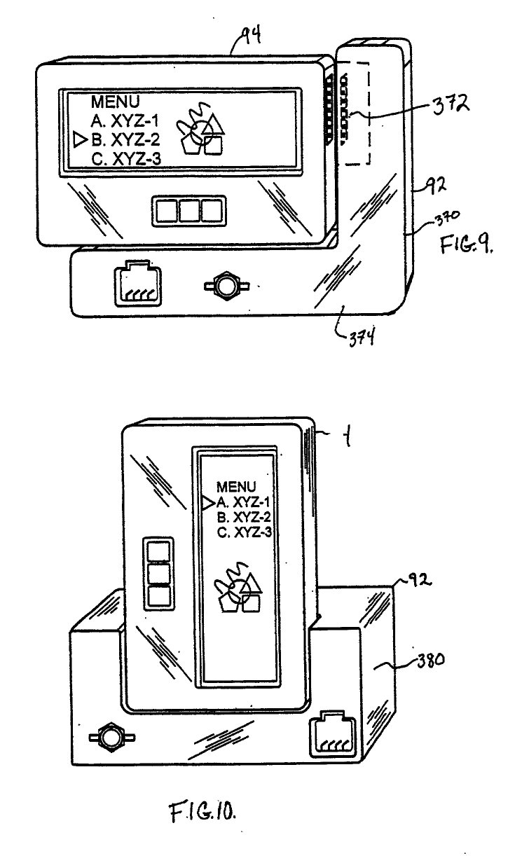

FIG. 13 is an illustrative diagram of an example process for combining a ditigal data bitstream with an analog video image for broadcasting over the broadcast network 74. The Data Broadcast Center 70 simultaneously preprocesses a television broadcast video image 420 and a data bitstream 424 before combination. The Data Broadcast Center 70 performs image size reduction of the video image 420 to generate a reduction of the original video image 422 in a display area 428. An area 425 surrounding the reduced video image 422 is void of any image information. The amount and type of reduction and the location of the reduced image 422 within the display area 428 is determined dynamically according to the coordinated transmission characteristics.

The Data Broadcast Center 70 preprocesses the data bitstream 424 by modulating segments of the data bitstream 424 into part or all of the image display area 428. The data bitstream 424 is modulated into the border area 425 of the display area 428 according to the coordinated transmission characteristics. Within the border area 425 the data bitstream 424 is modulated as image data. The data bitstream 424 is also modulated as non-viewable data (i.e. the blacker-than-black portion of the video image signal) within a blank area 453 the same size and location as the reduced image 422 and is superimposed on the reduced image 422 when combined. The reduced image 422 and the modulated bitstream are combined to generate a combined broadcast image 434 The Data Broadcast Center 70 or the Data Products Center 66 includes software and/or hardware components for performing the image reduction, the bitstream modulation, and the combination of the preproccessed information. The combined broadcast image 434 is generated in this format so as to be viewable on conventional televisions (i.e. televisions without the decoders/demodulators of the Subscriber Interface Unit 92 or the Portable Data Unit 94). Other methods of including data within a television broadcast signal are an overscan methods (Yes! Entertainment Corp.) that replaces the transmitted video signal with digitally encoded information and sub-video methods (Digideck, Inc.) that distribute ancillary signals throughout the visible image in a way that is imperceptible to the viewer.

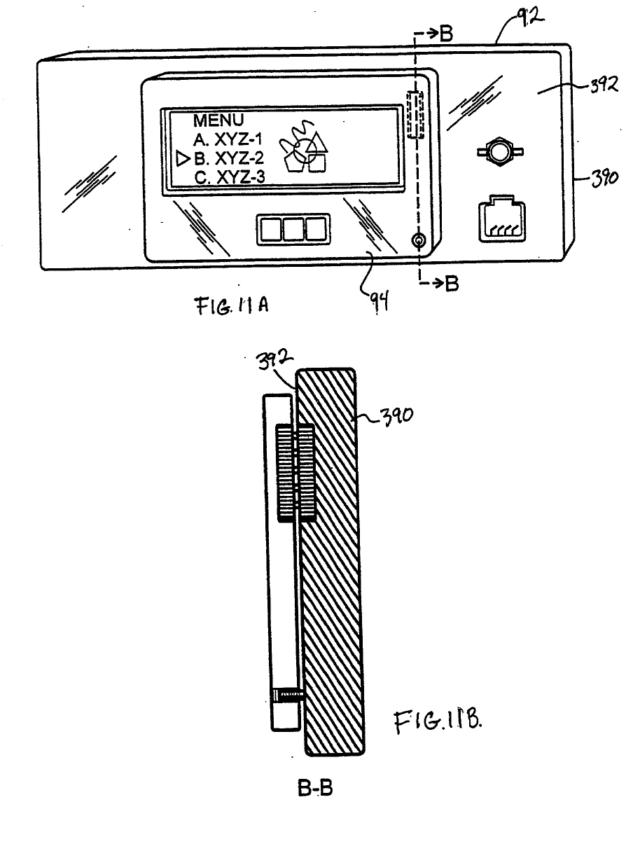

FIG. 14 illustrates processing performed at the Subscriber Interface Unit 92 or the Portable Data Unit 94 on the combined broadcast image 434 from the data and image combination process of FIG. 13. The combined broadcast image 434 is separated into its component parts, the reduced television broadcast image 422 and the modulated data bitstream image 429 by a separation component of the decoder/demodulator 108, 128. The separated reduced image 422, is sent to a display, such as the user interfaces of the Subscriber Interface Unit 92 or the Portable Data Unit 94 or a display device in communication with the Subscriber Interface Unit 92 or the Portable Data Unit 94, for presentation. The modulated data bitstream within the display area 428 is decoded/demodulated by the decoder/demodulator 108 or 128 into a bitstream 430 identical or nearly identical to the original data bitstream 424, depending upon transmission characteristics for the original data bitstream 424. The resulting data bitstream 420 is processed and presented and/or saved by the Subscriber Interface Unit 92 or the Portable Data Unit 94. In an alternate embodiment, the reduced image 422 is enlarged to a full-sized image 432 by an image size enlargement component of the Subscriber Interface Unit 92 or the Portable Data Unit 94, and then is presented.

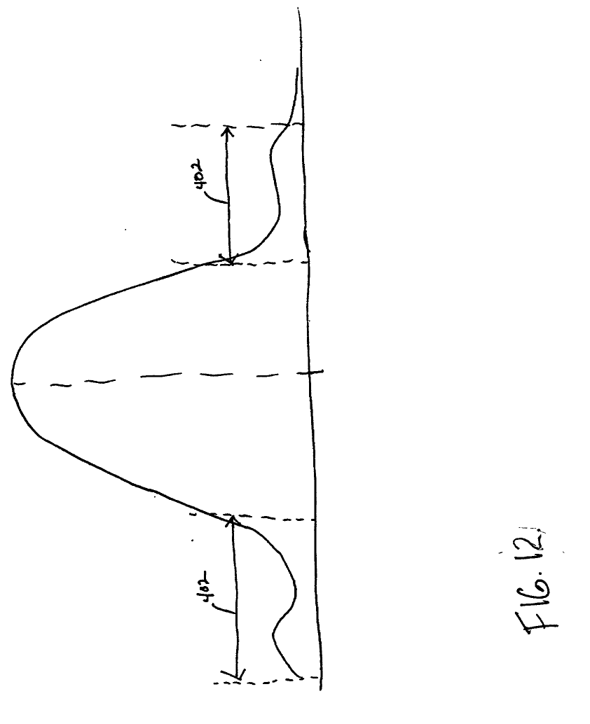

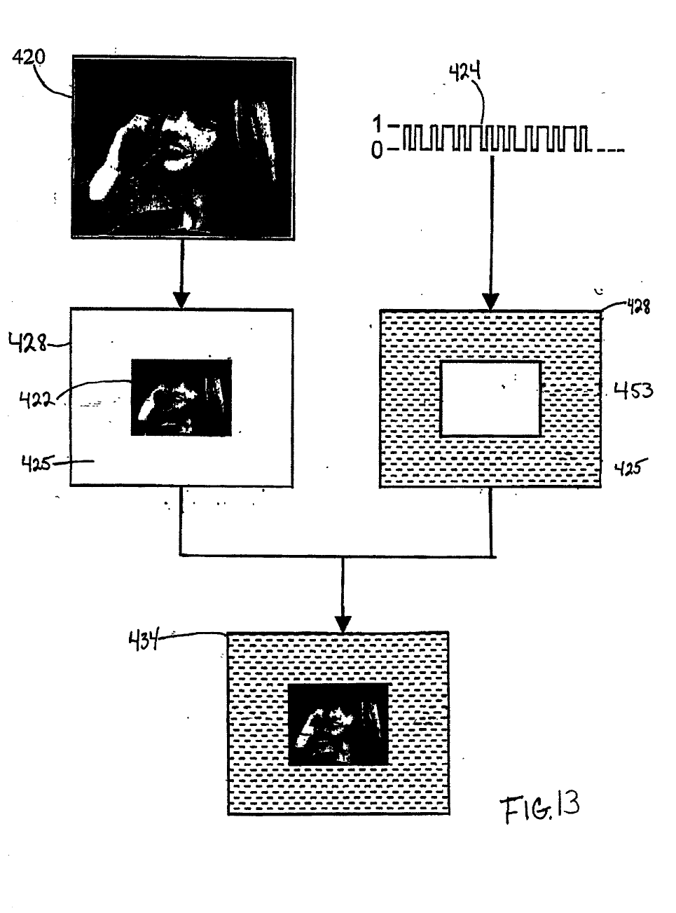

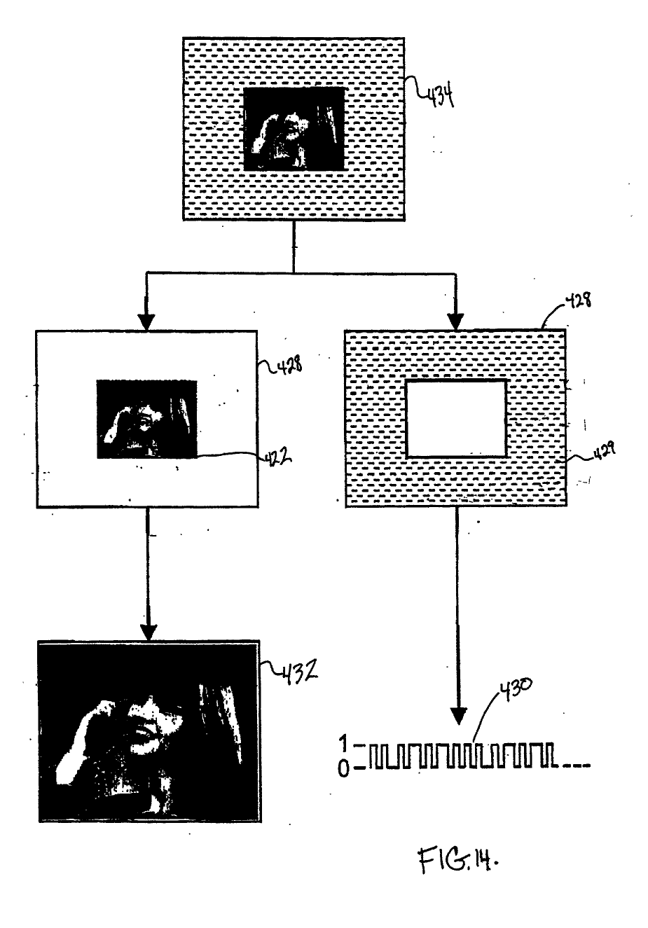

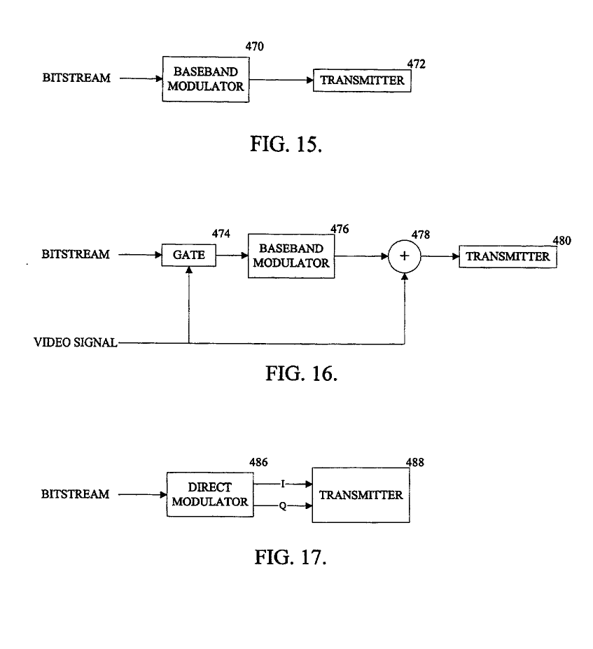

FIGS. 15-17 illustrate three example setups of components within the Data Broadcast Center 70 for inserting a data bitstream containing data products or related information into a broadcast video signal. As shown in FIG. 15, the data bitstream is modulated by a baseband modulator 470 then sent to a transmitter 472 for transmission to the receiving systems.

As shown in FIG. 16, the bitstream passes through a gate 474 with the broadcast video signal to a baseband modulator 476. The result of the baseband modulator 476, a modulated bitstream, is combined with the broadcast video signal at a combiner 478 and then sent to a transmitter 480 for transmission to the receiving systems. A more detailed example of this modulator/transmitter is illustrated in FIG. 18 below.

As shown in FIG. 17, the bitstream passes through a direct modulator 486 to form I and Q video signals for transmission by a transmitter 488.

FIG. 18 illustrates an example function diagram for performing the data bitstream and video signal combination for video signals generated according to NTSC standards. The video signal from a television broadcaster 72 or other video source and the data bitstream from the Data Product Center 66 are sent through a multiplexer 500 to a bandpass filter 502. The data bitstream is also sent directly to the bandpass filter 502. The result of the bandpass filter 502 is then sent through a color burst notch filter 504 for making space for the color burst at approximately 3.58 MHz. The video image is filtered by a low pass filter 506 then sent to a combiner 508 for combining with the result of the notch filter 506, thereby producing a composite video and data signal, such as the one that produces the combined data and video image 434 shown in FIG. 13. In this embodiment the video image portion of the video signal is located in a low pass area and the data bitstream is placed in a high pass area. The data bitstream is modulated onto a color subcarrier signal that is phase locked to the color burst with the frequency of approximately 3.58 MHz removed. FIG. 19 illustrates signal distribution according to the function diagram of FIG. 18.

FIG. 20 illustrates a video signal 520 (in NTSC format) with dashed locations that identify locations where the modulated bitstream is inserted. A first data modulation location 522 is at the base of the horizontal sync pulse of the video signal 520. A second data modulation location 524 is with or around the color burst. A third data modulation location 526 is within or below the video image portion of the video signal 520. A fourth data modulation location 528 is located after the video image portion of the video signal 520 and before the next horizontal sync pulse.

In an alternate embodiment, the data bitstream within locations 524, 526 and 528 is modulated to be invisible to viewers by limiting the amplitude levels of the modulated bitstream to remain below 0 IRE units (i. e. The 0 to −40 IRE), thereby producing blacker-than-black signals. In order to avoid sync pulse detection, a modulation technique, such as a fast modulation technique, is used with zero average DC content, like Manchester encoding, with an average amplitude of approximately 0 IRE. Other modulation formats that avoid sync pulse triggering can be used, such as phase modulation of the color subcarrier or other high frequency subcarriers with an average amplitude of 0 IRE or less.

In an alternate embodiment, a modulation technique with both amplitude and phase modulation is used with a transition density sufficient to be too fast for luminance circuits to analyze and with an average luminance level near or below 0 IRE.

In an alternate embodiment, the signal-to-noise (s/n) ratio is improved by raising luminance level above 0 IRE and scaling the peak amplitude of color subcarrier and the predefined step levels corresponding to discrete digital data states upwards, as long as the lowest levels stay above −40 IRE and highest level below 100 IRE.

In another embodiment, the luminance level is modulated as well as chrominance and color (i.e. phase). The luminance is modulated in ways so as not to interfere with the chrominance modulation.

The modulation techniques of a data bitstream and subcarriers utilize amplitude and/or phase modulation in discrete steps. The step size and levels are controlled and selected for optimizing the conflicting requirements of data rate and data robustness. Examples of such techniques include QAM, 8-VSB, BPSK, QPSK, MSK, COFDM and other known modulation techniques.

For digital modulation forming analog feed to video-input of TV transmitter, where horizontal and vertical sync pulses are required, in one embodiment the main bitstream may be segmented to fit between sync pulses. The packet length may be selected to match the bit stream segment length. In such cases, clock recovery (and also bit error rate) may be improved by starting each bit stream segment with a synchronization pulse sequence. Alternatively, the color burst may also be used for clock synchronization in some cases.

Each packet or bit stream segment could have control information, such as data type, packet number, start/stop delimiters or packet length, error detection and correction bits, and other information useful for reassembly of data at the receiver. Video frames may have additional information, such as station identification, channel control, system status, programming guides, or other system-level information. Such systems information may be contained within packets or bit stream segments, which may be designated for such types of information.

Packets may be shorter than one horizontal video line if that works out better for efficiency (such as where the data to be transported is already formed as small packets) or if transport over noisy channels favors short packets.

Where video images occupy part of the video frame and data is sent in the unused parts of the video frame, the bit stream segment's size may be adjusted to fit into the unused portions of the video frame, and also within each line. Clock synchronization pulses may be repeated at the resumption of each bit stream segment.

In another embodiment, hierarchical data rate structures or divided bandwidth modulation is used to permit transmission at multiple simultaneous data rates to address different markets, such as home or car, or software or music.

Certain forms of data, such as software, will require 0 errors, while others, such as music or video, can tolerate some errors as long as their rate is low enough and their grouping sparse enough to be masked by smoothing and decompression techniques.

Advanced multiple-level interleaving techniques can be used to decorrelate long bursts of noise from data. Each level of interleaving has its own Forward Error Correction (FEC), which can be different at each level. For example, inner code can be Trellis-coded modulation (convolutional coding) with R=1/2 to 2/3; outer code is Reed-Solomon (R is coding rate). However, a variety of such coding methods may be used in accordance with the present invention.

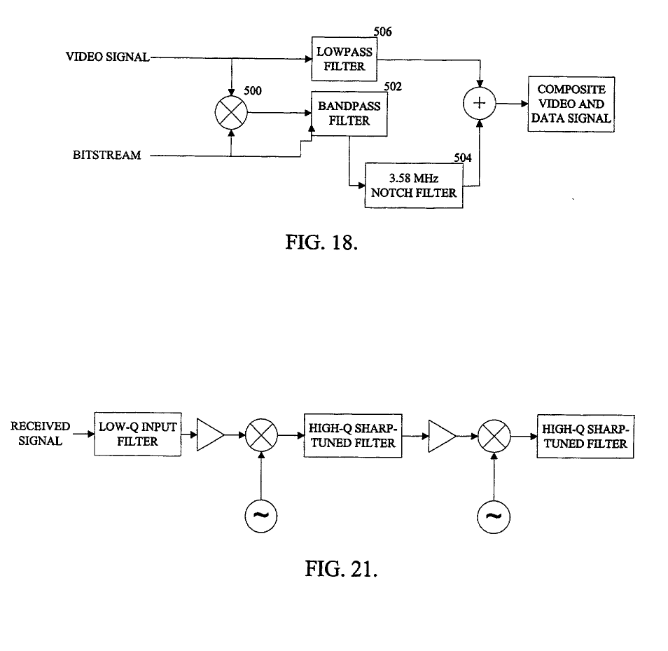

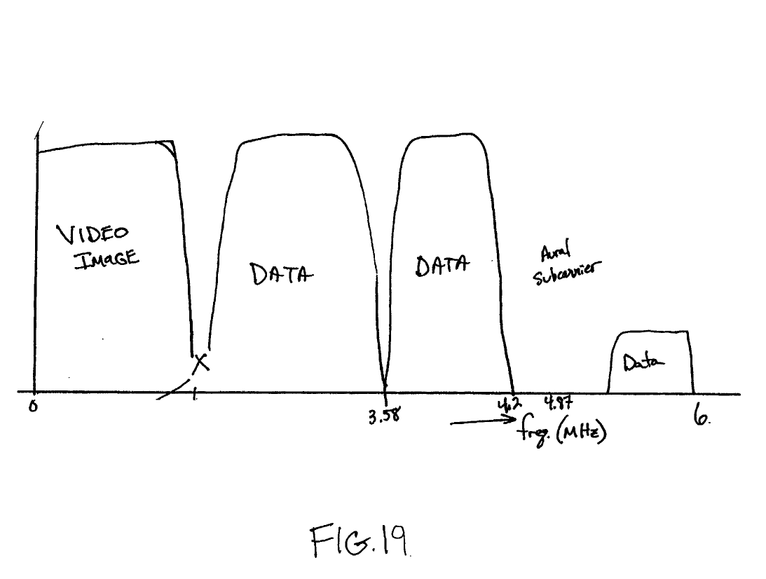

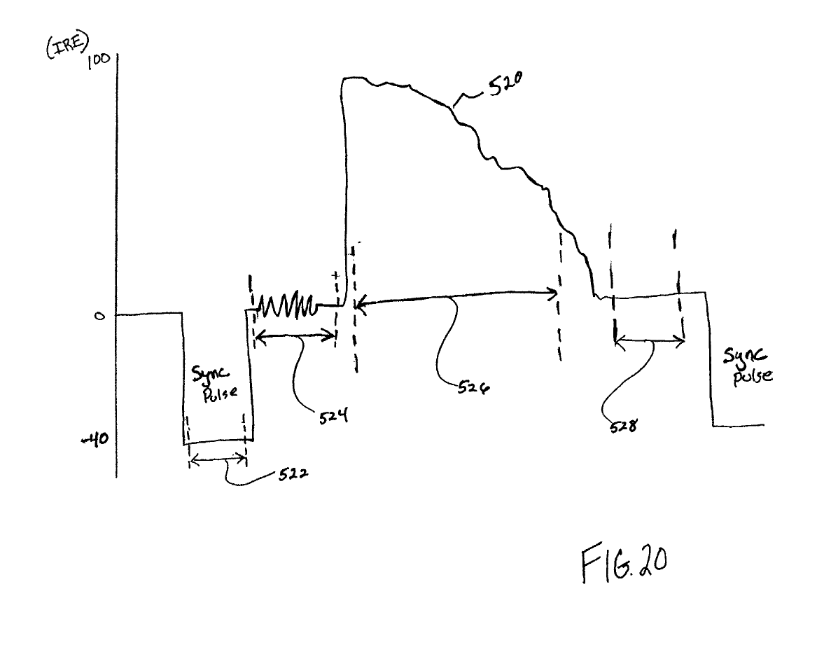

Receivers find, recognize, receive, demodulate, and decode signals from various sources at various frequencies with various bandwidths, modulation methods, encoding formats, and other features. Receivers are desired to quickly and easily find and recognize such signals, and to select the proper demodulation and decoding methods. Such methods include: frequency agility; adjustable IF selectivity filter passband (shown in FIG. 21); spectral analysis; signature detection; and table look-up.

Frequency agility refers to a method of adjustable tuning of the frequency of receiver and subcarrier tuners and demodulators, such that an appropriate frequency carrying a particular data channel is transmitted and received.

FIG. 21 illustrates an adjustable IF selectivity passband filter according to the present invention. Input filter 704 is low-Q for image reduction, good insertion loss and front-end noise figure, and low broadband noise into a low noise amplifier (LNA) 708 and mixer 710 for low intermodulation and good noise figure. First and second High-Q sharp-tuned filters 714 and 730 typically have similar sharp cutoff passbands, at least as wide as widest desired signal passband. A first Voltage Controlled Oscillator (VCO) 712 is tuned to place signal center frequency after mixer 710 at a frequency relative to the corner frequencies of the first filter 714 so that at least one side of the signal passband is filtered by at least one side of the first filter's 714 passband. A second VCO 724 is likewise tuned so that the frequency after a second mixer 722 is placed at a frequency relative to the corner frequencies of the second filter 730 so that at least the other side of the signal's passband is filtered by at least one side of the second filter's 730 passband. This process results in a program mobile format signal passband shape similar to opposite passband sides of the first and second filters 714 and 730 with adjustable bandwidth.

The use of spectral analysis in a receiver according to the present invention correlates the center frequency of detected signal with its bandwidth, bandshape, sideband characteristics, such as frequencies and shapes, and other products of modulation to look up in table its most likely modulation format and encoding method.

Signature detection according to the present invention comprises intentional signal content transmitted for easy and quick recognition of system signals or carriers. Several examples of signatures are subcarriers transmitted in addition to main signal content. Such subcarriers could employ low data rate and modulation methods that allow reliable data or signal demodulation at low signal-to-noise ratios and low subcarrier levels. Thus, the subcarriers could be placed in narrow unused sections of the signal's available spectrum, or spread out beyond the main signal's frequency content within the allowable signal spectrum mask. Even the mere presence of a subcarrier at a specific frequency, and perhaps its bandwidth and band shape, could be used as all or part of a signature. The subcarrier data or signal content could also be used for signature purposes, as well as for station and network identification.

Data or analog signal content can be included within the TV sync pulse or color burst period of TV signals (such TV signals could also contain data encoded into the video portion of the signal). Such data or other signal content can also be encoded into the main part of the signal modulated onto the carrier. Such data or other signal could form a virtual subchannel within the data stream or signal content. Other signal content used for signature purposes could be tones, tone envelopes, multi-tone relationships of frequency and or phase, waveforms, pulses, pulse widths, multipulse relationships or other forms of modulation.

Finally, a table look-up may be used that includes the most likely signal formats based on signal center frequency, followed by successful demodulation and decoding of the signal. Success could be determined by low bit error rates determined by matching error detection data read from the signal with correlated data calculated from the data content; by successful clock recovery of data clocks determined by clock detectors and clock frequency or other means; by successful decryption of encrypted signals.

Data Transmission With Extended Range and Gradual Degradation

Present digital transmission methods result in perfect transmission of the data until data loss begins to become intolerable, at which time the data transmission degrades dramatically. For example, an MPEG movie will appear almost perfect until signal errors cause massive failure of the video image, resulting in large pixelation and other unacceptable failures. One embodiment of the present invention utilizes techniques for transmitting multimedia content to provide for gradual degradation of the transmitted digital signal. These techniques may be valuable in circumstances where a perfect reproduction is not necessary and a variety of impairments such as multipath interference, impulse noise, fading, signal interference and other impairments are present.

Such a transmission method, while lacking the high quality reproducibility commonly found in digital transmissions, has advantages over existing analog transmissions. These advantages include efficient spectrum usage, increased performance, flexibility to interleave data from multiple sources such as programs, files and control subchannels, security features such as encryption and identification authentication, transmitter or system identification authentication sent with desired data or the carrier analog broadcast that may be invisible to the user or presented in programmable formats. A further advantage is the flexibility to alter modulation formats and/or data rates and to reduce the amount of data or bandwidth needed to convey the information content depending upon the source material including through digital compression techniques, thereby allowing additional data to be transmitted. These techniques may also allow for beneficial trade-offs in performance, such as increasing coverage area or operating with lower signal-to-noise (S/N) rations while reducing signal bandwidth, resolution or other characteristics of the information.

One such technique is to divide the input information or content into a number of its components according to the rate of change of one or more of its principal characteristics and then to transmit these components on different sub-channels with different characteristics that trade off data rates for robustness or bit error rate (BER) under the applicable channel impairments. The nature and degree of such division and trade-off may be predetermined or may be determined dynamically.

The principal characteristics may be in either the time domain, such as amplitude variations of voltage or brightness or pressure, etc. or they may be in the frequency domain, such as the amplitude and phase of the main frequency components of the variations in information or content versus time.

The greater the number of subchannels into which these components are divided, the finer the resolution of performance degradation as the channel impairments worsen, or the broader the range of degradation.

In addition, compression of the signal content and/or the data may be combined with these means to greatly improve its effectiveness. Encryption and decryption of some or all of the divided and compressed data could provide secure transmission and reception of the content or information.

Narrowband subcarriers used for the subchannels could have bandwidths that varied as necessary with the data rate for each subchannel. Subchannels with low data rates would normally be narrower in bandwidth than those with high data rates, and would have correspondingly better reception in the presence of noise or other impairments.

Another method of creating subchannels would be to use Direct Sequence Spread Spectrum (DSSS) to spread carriers or subcarriers separately for each subchannel using different spreading codes at different rates to spread each subchannel by a different ration of chips (i.e. spreading code) to data bits, thereby achieving better decorrelation and rejection of in-band noise for the subchannels with higher spreading ratios. The subchannels could be created with the same or different center frequencies.

In a further method a compression algorithm could send amplitude, frequencies and phase information for each significant spectral component, and then update them as they change. Receivers could then reconstruct the original waveform from this information.

Assuming that the higher frequency spectral components of the signal changed more rapidly than the low frequency components, one method of dividing the signal components into subchannels could be based on the component frequency, with higher frequency components sampled more frequently, and sent via higher data-rate subchannels.

A still further method of dividing and transmitting signal components into subchannels is to assign information from widely spaced (in time) samples (“spectral snapshots”) to lower data-rate high-priority subchannels, and to “fill-in” the intervening time samples into the higher data-rate low-priority subchannels. The receiver could perform this “filling-in” by interpolation or extrapolation form missing samples.

Yet another method of dividing signal components into subchannels is by the amount of change of the signal characteristic being sampled, whether in the time or frequency domain. Large changes could be assigned to lower data-rate high-priority subchannels.

While the preferred embodiment of the invention has been illustrated and described, many changes can be made without departing from the spirit and scope of the invention. Accordingly, the scope of the invention is not limited by the disclosure of the preferred embodiment. Instead, the invention should be determined entirely by reference to the claims that follow.

We claim:

1. A system for delivery of data products from vendor systems to portable receiving systems, the system comprising:
a data product center, coupled to the portable receiving systems and the vendor systems over one or more communication networks, for storing data products and data product information sent from the vendor systems, receiving data product requests from the portable receiving systems, and generating delivery packets of one or more stored data products or data product information according to at least one of the received data product requests prestored delivery instructions; and
a data broadcast center coupled to the data product center over a communications network for combining the generated delivery packets with a broadcast signal and for transmitting the combination to one or more portable receiving systems over a broadcast network.

2. The system of claim 1, further comprising an entertainment broadcaster coupled to the data broadcast center over a communications network for generating the broadcast signal.

3. The system of claim 1, wherein the data product center is distributed over a network.

4. The system of claim 1, wherein the broadcast signal is an analog signal.

5. A portable receiving system for receiving data products and data product information comprising:
a portable data unit comprising:
a broadcast signal receiver for receiving at least one of a data product or data product information modulated with a broadcast signal;
a processor for separating the at least one data product or data product information from the broadcast signal by demodulating the broadcast signal;
memory for storing the separated at least one data product or data product information;
a presentation device for presenting the separated at least one data product or data product information; and
a user interface for allowing selection of a data product associated with the presented data product or data product information; and
a subscriber interface unit comprising:
a network interface for connecting the subscriber interface unit to a data product center over a communications network; and
an interface for connecting to the portable data unit.

6. The system of claim 5, wherein the subscriber interface unit further comprises a processor, memory, a user interface and a display device.

7. The system of claim 6, wherein the subscriber interface unit further comprises a broadcast signal receiver.

8. The system of claim 5, wherein the network interface is a personal computer interface.

9. The system of claim 5, wherein the por table data unit comprises a housing shaped similar to an audio cassette and the subscriber interface unit is shaped to receive the portable data unit.

10. The system of claim 9, wherein a portion of the memory is removable from the portable data unit housing.

11. The system of claim 9, wherein the display and user interface are located on one side of the portable data unit housing.

12. The system of claim 9, wherein the portable data unit housing comprises a battery compartment.

13. The system of claim 9, wherein the portable data unit further comprises an output component for generating a signal for reception by at least one of an analog or digital cassette recorder.

14. A method for sending a data product within an analog radio signal and receiving the sent data product at a portable data unit, the method comprising:
sending data products and data product information from a plurality of vendors to a data product center over a communications network;
storing at the data product center the sent data products and data product information;
sending one or more stored data products and data product information to a data broadcast center;
at the data broadcast center, modulating at least one of one or more data products and data product information within a radio signal;
transmitting the modulated signal;
receiving the transmitted signal at a portable data unit;
demodulating the received signal into the radio signal and at least one of the data products or the data product information; and
presenting at least a portion of at least one of the data products or the data product information.

15. The method of claim 14, wherein presenting comprises displaying at least a portion of at least one of the data products or the data product information.

16. The method of claim 14, wherein presenting comprises resonating a sound corresponding to at least a portion of at least one of the data products or the data product information.

17. The method of claim 14, further comprising selecting at the portable data unit a data product according to the presentation and sending the selection to the data product center over a communications network.

18. The method of claim 14, wherein modulating comprises modulating at least one of the one or more data products and data product information within one or more range of sideband frequencies.

19. The method of claim 19, further comprising:
determining at the portable data unit reception capabilities;
sending the determined reception capabilities to the data product center over a communications network; and
modulating at least one of one or more data products and data product information according to the sent reception capabilities.

20. A method for sending a data product within an analog television signal and receiving the sent data product at a portable data unit, the method comprising:
sending data products and data product information from a plurality of vendors to a data product center over a communications network;
storing at the data product center the sent data products and data product information;
sending one or more stored data products and data product information to a data broadcast center;
at the data broadcast center, modulating at least one of one or more data products and data product information within a television signal;
transmitting the modulated signal;
receiving the transmitted signal at a portable data unit;
demodulating the received signal into the television signal and at least one of the data products or the data product information; and
presenting at least a portion of at least one of the data products or the data product information.

21. The method of claim 20, wherein presenting comprises displaying at least a portion of at least one of the data products or the data product information.

22. The method of claim 20, wherein presenting comprises resonating a sound corresponding to at least a portion of at least one of the data products or the data product information.

23. The method of claim 20, further comprising selecting at the portable data unit a data product according to the presentation and sending the selection to the data product center over a communications network.

24. The method of claim 20, wherein modulating comprises modulating at least one of the one or more data products and data product information within a portion of the horizontal sync pulse of the television signal.

25. The method of claim 20, wherein modulating comprises modulating at least one of the one or more data products and data product information within a portion of the color burst of the television signal.

26. The method of claim 20, wherein modulating comprises modulating at least one of the one or more data products and data product information within the image portion of the television signal.

27. The method of claim 20, wherein modulating comprises modulating at least one of the one or more data products and data product information after the image portion of the television signal.

28. The method of claim 20, further comprising:
determining at the portable data unit reception capabilities;
sending the determined reception capabilities to the data product center over a communications network; and
modulating at least one of one or more data products and data product information according to the sent reception capabilities.
